(19) United States
(12) Patent Application Publication
(10) Pub. No.: US 2026/0043453 A1
(43) Pub. Date: Feb. 12, 2026

(54) DAMPING VALVE DEVICE FOR A VIBRATION DAMPER

(71) Applicants: thyssenkrupp Bilstein GmbH, Ennepetal (DE); thyssenkrupp AG, Essen (DE)

(72) Inventor: Freddy WOENARTA, Braunschweig (DE)

(73) Assignees: thyssenkrupp Bilstein GmbH, Ennepetal (DE); thyssenkrupp AG, Essen (DE)

(21) Appl. No.: 18/998,678

(22) PCT Filed: Jul. 19, 2023
(86) PCT No.: PCT/EP2023/070050

§ 371 Date: Jan. 27, 2025

(30) Foreign Application Priority Data
Jul. 27, 2022 (DE) 10 2022 207 701.6
Jul. 27, 2022 (LU) LU 102987

(51) Int. Cl. F16F 9/46; F16F 9/34

(52) U.S. Cl. CPC F16F 9/466; F16F 9/34

(57) ABSTRACT

A damping valve device for a hydraulic vibration damper for a vehicle comprises: a drive region and a valve region, and a damping valve housing with a tube part which encloses the drive region and the valve region, wherein the drive region has a coil which is configured in such a way that it generates a magnetic circuit within the damping valve device and interacts with an armature, attached axially movably within the coil, in order to move the armature in the axial direction, wherein the armature is arranged within a pole tube, and the pole tube forms a guide of the armature, attached axially movably within the coil, in order to move the armature in the axial direction, wherein the armature is arranged within a pole tube, and the pole tube forms a guide of the armature, wherein the valve region has a fluid inlet and a fluid outlet for admitting and discharging a hydraulic fluid into/out of the valve region, and a valve block with a plurality of flow passages for conducting the hydraulic fluid, wherein the valve region has a control slide which is attached such that it can be moved relative to the valve block in such a way that it can be moved between a closed position, in which the flow passages are closed by the control slide, and an open position, in which the flow passages are free, wherein a plurality of flow channels which extend at least partially in the radial and in the axial direction are configured between the pole tube and the valve block.

The invention relates to a damping valve device for a vibration damper, in particular for motor vehicles.

Vibration dampers, in particular shock absorbers, are normally used in motor vehicles and are attached between a wheel suspension system, in particular an axle, and the body of the vehicle, in order to damp shocks while traveling and to reduce vibrations. In order to increase the travel comfort and the road safety, the damping characteristic of the vibration damper is usually adjustable. For example, this takes place via a solenoid valve, via which the flow of the hydraulic fluid within the vibration damper is adjustable and therefore facilitates or hinders the movement of the piston of the vibration damper.

Solenoid valves are arranged, for example, on the outside of the vibration damper tube, and are therefore a module which is separate from the vibration damper tube and takes up additional installation space within the vehicle.

EP2685145A2 has disclosed a damping valve device which is attached to the outside of the vibration damper.

Proceeding herefrom, it is an object of the present invention to reduce the production costs, in particular the number and complexity of the components, the assembly time, and the weight of a damping valve device of a vibration damper.

According to the invention, this object is achieved by a damping valve device with the features of independent apparatus claim 1. Advantageous developments result from the dependent claims.

In accordance with a first aspect of the invention, a damping valve device for a hydraulic vibration damper for a vehicle, in particular a motor vehicle, comprises a drive region and a valve region. Furthermore, the damping valve device comprises a damping valve housing, with a tube part which encloses the drive region and the valve region, wherein the drive region has a coil which is configured in such a way that it generates a magnetic circuit within the damping valve device and interacts with an armature, attached axially movably within the coil, in order to move the armature in the axial direction. The armature is arranged within a pole tube, wherein the pole tube forms a guide of the armature. The valve region has a fluid inlet and a fluid outlet for admitting and discharging a hydraulic fluid into/out of the valve region, and a valve block with a plurality of flow passages for conducting the hydraulic fluid. The valve region has a control slide which is attached such that it can be moved relative to the valve block in such a way that it can be moved between a closed position, in which the flow passages are closed by the control slide, and an open position, in which the flow passages are free. A plurality of flow channels which extend at least partially in the radial and in the axial direction are configured between the pole tube and the valve block. The flow channels are preferably configured partially or completely by the pole tube and the valve block. In particular, the pole tube and the valve block directly adjoin the flow channels and delimit them. The flow channels are preferably arranged separately from one another, with the result that the flow channels are disconnected from one another at least partially or completely, in particular fluidically.

In accordance with a first embodiment, the valve block has a first cylindrical region and an adjoining second cylindrical region, wherein the second region has a greater diameter than the first region, and wherein the flow channels are configured in the second region. In accordance with a further embodiment, the flow passages are arranged in the first region.

In accordance with a further embodiment, the pole tube lies against the second region of the valve block. For example, the pole tube lies exclusively against the second region of the valve block and, in particular, is spaced apart from the first region. By way of example, the second region has a radially outwardly pointing peripheral surface and a shoulder surface which points axially in the direction of the first region. The shoulder surface preferably lies against the pole tube. The first region of the valve block is arranged, in particular, coaxially with respect to the control slide. The first region can preferably be enclosed completely or partially by the control slide. The flow passages are preferably circular bores in the valve block, in particular the wall of the first region of the valve block.

The flow channels are preferably configured in the second region of the valve block and are of open configuration, in particular, in the direction of the pole tube, with the result that the flow channels are each configured between the inner surface of the pole tube and the radially outwardly pointing surface of the valve block. The flow channels preferably extend from the shoulder surface to the peripheral surface and are, in particular, cutouts, preferably indentations, in the shoulder surface and the peripheral surface. The direction of extent of the flow channels preferably has an axial and a radial component. This makes an optimum flow of the damping fluid possible.

In accordance with a further embodiment, the flow channels extend, preferably continuously, at an angle of from 10° to 80°, in particular from 20° to 60°, preferably from 30° to 50° with respect to the axial orientation. The flow channels are, for example, of half shell-shaped configuration in the valve block and extend, in particular, in a star-shaped manner away from the first region, in particular the flow passages.

In accordance with a further embodiment, the number of flow channels corresponds to the number of flow passages. It is likewise conceivable that more flow channels than flow passages are provided or more flow passages than flow channels are provided. The number of flow channels preferably does not equal the number of flow passages.

In accordance with a further embodiment, at least one flow channel is arranged in an aligned manner with one of the flow passages. Each flow channel is preferably arranged in an aligned manner with a respective flow passage. An optimum flow of the damping fluid is achieved as a result. The flow channels are preferably arranged at the same height as at least one flow passage. In accordance with one embodiment, at least one flow channel is arranged offset with respect to the flow passages. It is likewise conceivable that all the flow channels are arranged offset with respect to the flow passages.

In accordance with a further embodiment, at least two flow passages are arranged at different height levels. The arrangement of the flow passages at different height levels brings about opening/closing of the flow passages by the control slide in a predetermined sequence. As a result, an optimum distribution of the transverse force acting on the control slide in the switching operation is made possible.

The flow passages are preferably arranged spaced apart from one another uniformly in the peripheral direction of the first region of the valve block. For example, at least two flow passages which are directly adjacent to one another are arranged at in each case different height levels. In particular, all the flow passages are arranged at in each case different height levels.

The height level is preferably to be understood to mean the spacing of the center point of the respective flow passage from a defined cross-sectional plane of the damping valve device. In particular, this is to be understood to mean the axial spacing of the center point of the respective flow passage from the shoulder surface of the second region of the valve block.

In accordance with a further embodiment, at least two flow passages are arranged at the same height level. As a result, simultaneous opening of the flow passages by means of the control slide is achieved, and the force distribution of the forces which act on the control slide in the switching operation of the damping valve is optimized.

In accordance with a further embodiment, flow passages which lie opposite one another peripherally on the valve block are arranged at the same height level. The valve block preferably has four, six, eight or ten flow passages which are arranged peripherally around the first region of the valve block, and wherein, in particular, respective adjacent flow passages are arranged offset at an angle with respect to one another of 90°, 60°, 45° or 36° about the center axis of the valve block. Flow passages which lie opposite one another are arranged offset with respect to one another by 180°. Simultaneous opening/closing of flow passages which lie opposite one another optimizes the force distribution of the forces which act on the control slide in the switching operation of the damping valve. As an alternative, flow passages which lie opposite one another peripherally on the valve block are arranged at different height levels.

In accordance with a further embodiment, flow passages which lie opposite one another peripherally on the valve block have a height level difference which is smaller than the height level difference from the respective directly adjacent flow passages. This brings about opening/closing immediately one after another of flow passages which lie opposite one another.

For example, at least two flow passages have different diameters. In accordance with a further embodiment, at least two flow passages have different geometries. All the flow passages preferably have different diameters and/or geometries. This makes optimum adjusting of the forces which act on the control slide in the switching operation of the damping valve possible.

In the following text, axial direction is to be understood to mean the direction which runs parallel to the axial center line of the damping valve device, in particular of the tube part of the damping valve device. Radial direction is to be understood to mean the direction which runs orthogonally with respect to the axial direction.

The hydraulic vibration damper preferably comprises an inner cylinder tube and an outer cylinder tube which is arranged coaxially with respect to the former and, in particular, forms the outer wall of the vibration damper. A piston is preferably attached axially movably to a piston rod within the inner cylinder tube and divides the inner cylinder tube into two working spaces. In particular, the piston has at least two fluid passages, by which the one working space is connected to the other working space. An annular space is preferably configured between the inner and the outer cylinder tube, wherein a center tube which divides the annular space is preferably attached within the annular space and coaxially between the inner and the outer cylinder tube. The damping valve device is preferably connected fluidically to at least one of the working spaces of the inner cylinder tube and is preferably attached to the center tube and the outer cylinder tube of the vibration damper. The vibration damper is preferably filled completely or partially with a hydraulic fluid.

The tube part is preferably configured in such a way that it can be connected to the outer cylinder tube and has, in particular, a substantially constant, circular cross section. The tube part preferably forms the outer housing wall of the damping valve device. In particular, the drive region and the valve region are arranged completely within the tube part, with the result that the tube part preferably extends in the axial direction beyond the drive region and/or the valve region. The valve region is preferably arranged in a region of the tube part which faces the outer cylinder tube of the vibration damper, wherein the drive region is arranged in the opposite region of the tube part which faces away from the outer cylinder tube of the vibration damper. The tube part is preferably configured from a magnetic or magnetizable material.

The drive region preferably comprises an electromagnet, wherein the electromagnet has, for example, a coil with a plurality of windings which are arranged on a coil former. The coil former is preferably configured from a plastic, is, in particular, of substantially hollow-cylindrical configuration, and is arranged coaxially with respect the tube part.

The coil is preferably connected to the tube part fixedly, in particular in an integrally joined, positively locking and/or non-positive manner. For example, a clearance fit is configured between the pole tube and the coil. The coil is preferably configured and arranged in such a way that it generates a magnetic circuit within the damping valve device. The coil which is loaded with an electrical current preferably generates a magnetic flux which runs in a closed path within the damping valve device. The magnetic circuit comprises the elements of the damping valve device, through which the magnetic flux which is generated by the coil runs in a closed path.

The armature is arranged within the coil, preferably coaxially with respect to the latter. The armature is preferably configured from a magnetic or magnetizable material and is, in particular, part of the magnetic circuit. The armature preferably has a first cylindrical region which is adjoined in the axial direction by a second cylindrical region with a smaller diameter relative to the first region. In particular, the pole tube is arranged between the armature and the coil, which pole tube is of at least partially hollow-cylindrical configuration and extends coaxially with respect to the coil, the tube part and the armature. The pole tube is preferably configured from a magnetic or magnetizable material and is, in particular, part of the magnetic circuit. For example, the armature is wrapped around at least partially or completely by a sliding foil such as, for example, PTFE foil, by way of which the axial movement of the armature within the pole tube is facilitated. The pole tube preferably has a hollow-cylindrical region which lies at least partially against the coil, in particular the coil former, and preferably has a substantially constant cross section. In particular, the hollow-cylindrical region has a substantially constant inner and/or outer diameter, in particular a constant wall thickness.

The hollow-cylindrical region preferably configures the guide, in particular axial guide, of the armature, with the result that the armature is attached movably in the axial direction within the pole tube. The hollow-cylindrical region of the pole tube preferably extends in the axial direction, preferably in the direction of the housing upper part, beyond the coil and, in particular at its end, has a bottom which completely closes the pole tube on the end side. A cylindrical armature space, in which the armature and hydraulic fluid are arranged, is preferably configured within the hollow-cylindrical region. The hollow-cylindrical region of the pole tube is adjoined, in a manner which points in the axial direction to the valve region, by a valve-side region which has at least one or a plurality of widened portions of the inner diameter and/or the outer diameter. The valve-side region of the pole tube is preferably of funnel-shaped configuration, wherein the funnel widens in the direction of the valve. The pole tube, in particular the valve-side region of the pole tube, is preferably connected fixedly to the tube part, in particular in a positively locking, non-positive and/or integrally joined manner. The pole tube extends, for example, in the axial direction at least partially or completely along the coil, the valve slide and the valve block.

The pole tube, in particular the valve-side region, preferably encloses the valve block and/or the control slide, in particular peripherally. An annular space which is filled with hydraulic fluid is preferably configured between the valve block and/or the control slide and the pole tube. The control slide is preferably attached movably in the axial direction relative to the valve block and the pole tube, and is arranged coaxially with respect to the tube part and the pole tube. The control slide is preferably operatively connected to the armature, with the result that the movement of the armature is coupled at least partially or completely to the control slide. The control slide preferably has an axial end surface which points in the direction of the armature and against which the armature lies, with the result that a movement of the armature is transmitted to the control slide.

The valve block is preferably arranged coaxially with respect to the pole tube and has, in particular, a cavity which is connected fluidically to the fluid inlet/fluid outlet, with the result that hydraulic fluid flows into the valve block. A fluid space, in which the hydraulic fluid can flow, is preferably configured between the valve block and the pole tube. The valve block is, for example, of funnel-shaped configuration and by way of example has a cylindrical region which faces the drive unit, is arranged coaxially with respect to the control slide and preferably has a substantially constant cross section. The control slide preferably encloses the valve block peripherally and is mounted movably in the axial direction relative to the valve block. The valve block has, for example, a funnel-shaped, radial widened portion on the region which faces away from the drive unit. The valve block is attached, in particular, in a stationary manner relative to the axially movable control slide and is connected, for example, fixedly to the pole tube. The valve block is preferably enclosed peripherally and in the axial direction at least partially or completely by the pole tube element, wherein the control slide is arranged between the drive-side region of the valve block and the pole tube element.

Flow passages, in particular through openings, through which the hydraulic fluid can flow, in particular, from the fluid inlet to the fluid outlet, are preferably configured within the valve block. The flow passages are preferably arranged in the cylindrical region of the valve block which is enclosed by the control slide. The control slide is attached axially movably in such a way that it completely releases the flow passages in an open position of the damping valve device and completely closes the flow passages in a closed position of the damping valve device. The control slide is mounted in such a way that it can preferably be moved into a multiplicity of intermediate positions, in which the flow passages are partially closed. The control slide is preferably preloaded in the direction of the open position by means of a spring. The spring is preferably arranged between the control slide and the valve block, and preferably loads the control slide with a force which acts axially in the direction of the drive region.

The pole tube is preferably configured in one piece. “One piece” is preferably understood to mean configured in one piece, in particular a solid block, wherein “in one part” includes a fixed connection between a plurality of parts, for example by means of a positively locking, non-positive and/or integrally joined connection. A pole tube which is configured in one piece or in one part facilitates the assembly of the damping valve device considerably. Complicated assembly of the pole tube is no longer necessary. In addition, fastening means for assembling a multiple-part pole tube are dispensed with, which leads to a weight saving. A further weight saving is achieved by the fact that the tube part is part of the magnetic circuit, since at least one part of the coil former, in particular the outer shell, can be dispensed with in this way. For example, the pole tube is produced by a machining method, in particular turning or milling. In particular, the pole tube is produced by casting or cold working.

The damping valve device has, for example, a sealing element which is arranged in a chamber, wherein the chamber is configured between the pole tube and the tube part and additionally the coil and/or a supporting ring. The chamber is preferably closed by the pole tube and the tube part, and additionally the coil and/or the supporting element. The chamber is preferably configured to receive a sealing element, in particular a sealing ring. The chamber is preferably of circularly annular configuration and has, in particular, a rectangular cross section. The chamber is, in particular, completely closed and is delimited by the pole tube, the tube part and the coil and/or the supporting ring. A sealing element, which is preferably a sealing ring, is attached in the chamber. The sealing element preferably lies at least against the pole tube and the tube part and serves, in particular, for sealing purposes, with the result that no hydraulic fluid passes from the valve region into the coil. In particular, the sealing element additionally lies against the shoulder of the pole tube.

A chamber, for receiving the sealing element, which is configured between the pole tube and the tube part and additionally the coil and/or a supporting ring makes simple assembly of the sealing element on the pole tube possible. In particular, damage of a sealing element which is configured as a sealing ring is avoided, since this can be assembled as far as possible in an unstressed state.

For example, the sealing element is configured as an O-ring. The sealing element is preferably configured from a plastic, in particular an elastomer. The sealing element is, in particular, of circularly annular configuration and preferably has a round, in particular circular, cross section. The cross-sectional diameter of the sealing ring is preferably greater than the cross-sectional width of the chamber, with the result that it preferably lies against at least three inner surfaces of the chamber.

In particular, the pole tube has a radial shoulder which adjoins the chamber. The radial shoulder is preferably a radial widened portion of the pole tube relative to a region of the pole tube which directly adjoins in the direction of the housing upper part. The pole tube preferably has a plurality of different outer diameters, wherein the outer diameter of the pole tube decreases, in particular, from the chamber in the direction of the housing upper part. The outer diameter of the pole tube within the chamber is preferably greater than or equal to the outer diameter of that region of the pole tube which extends from the chamber in the direction of the housing upper part. As a result, pushing the sealing ring onto the pole tube is facilitated.

In the axial direction from the drive region in the direction of the valve region, the pole tube preferably has a first outer diameter which is arranged within the coil. This is adjoined, for example, by a second outer diameter which is greater than the first outer diameter, with the result that a shoulder, in particular an axial end surface, is formed which points in the direction of the housing upper part and against which the coil preferably lies at least partially. The second outer diameter is preferably spaced apart from the inner diameter of the tube part in such a way that the chamber is configured between the pole tube and the tube part. The second outer diameter is preferably adjoined by a third outer diameter of the pole tube which is greater than the first and the second outer diameter and preferably corresponds substantially to the inner diameter of the tube part, with the result that the pole tube lies with the third outer diameter against the tube part. An axial end surface which points in the direction of the housing upper part and adjoins the chamber is preferably configured between the second and the third outer diameter.

For example, the coil has a projection which runs in the axial direction and adjoins the chamber. The coil preferably has a receptacle, to which the windings and the coil former are connected fixedly. In particular, the receptacle is configured from a plastic which is preferably applied by means of injection molding at least partially or completely around the windings and the coil former. The plastic material is preferably molded onto the windings and the coil former. The receptacle preferably forms that shell surface of the coil which points in the direction of the tube part, and lies, in particular, against the tube part. The receptacle is configured, for example, in one part or in one piece with the housing upper part. The receptacle is preferably connected via a clearance fit or fixedly to the tube part, in particular in a non-positive, integrally joined and/or positively locking manner. The coil preferably has a projection which runs in the axial direction, in particular along the inner wall of the tube part, extends between the tube part and the pole part, and adjoins the chamber. The projection is preferably configured from a plastic. The projection is preferably configured in the receptacle or the coil former of the coil. That end face of the projection which points in the valve direction preferably configures a boundary of the chamber. The pole tube and the tube part are preferably connected to one another via a positively locking connection, in particular via a bayonet fitting. The positively locking connection has, for example, at least one axial recess which is configured in the pole tube and opens into the chamber. The positively locking connection is, in particular, a bayonet connection. For example, the pole tube has a plurality of cutouts which are, in particular, of hook-shaped configuration. Each cutout comprises, for example, a region which runs, in particular, in the axial direction and a region which adjoins the latter and runs in the radial direction. A radial constriction of the tube part preferably engages in each case into the cutout. The cutouts are preferably radial depressions which are configured in the outer surface of the pole tube which lies against the tube part. The cutouts preferably extend into the chamber and form, in particular, interruptions of the contact surface of the sealing element. In this case, the sealing element 13 preferably has depressions and projections, wherein the projections engage into the cutouts of the pole tube 7 and configure, for example, a positively locking connection.

The damping valve device has, for example, a supporting ring which is arranged separately with respect to the coil. The supporting ring preferably lies at least partially with an outer surface against the coil. The supporting ring is preferably of circularly annular configuration and has, for example, a rectangular cross section. In particular, the supporting ring 15 lies with its outer surface against the inner side of the tube part and with its inner surface against the outer surface of the pole tube. That end surface of the supporting ring which points in the valve direction adjoins, in particular, the chamber. The supporting ring is preferably connected fixedly to the coil, the pole tube and/or the tube part. The supporting ring preferably forms a bearing surface for the sealing element. The projection of the coil is provided, for example, as an alternative to or together with the supporting ring.

For example, the pole tube has a hollow-cylindrical region which is arranged within the coil, and wherein the hollow-cylindrical region has a recess which runs in the peripheral direction. The recess is preferably configured in the pole tube between the coil and the armature and is, for example, of circularly annular configuration. The recess preferably extends in the peripheral direction of the pole tube completely in a closed ring around the pole tube or has interruptions. In particular, the recess extends in the radial direction from the outside toward the inside into the pole tube. The depth of the recess is preferably smaller than the wall thickness of the pole tube, with the result that the recess does not configure an opening. The recess is filled, in particular, completely or partially with a material, in particular a magnetically insulating material such as plastic. For example, the recess is filled completely or partially with ambient air. The recess preferably has a cross section with a valve-side region which widens in the radial direction from the inside toward the outside in the direction of the valve region. In the region of the recess, the pole tube preferably has a conical region which serves for the introduction of the magnetic flux into the armature. In the direction of the housing upper part, the valve-side region of the recess is adjoined, for example, by a region with a rectangular, in particular square, cross section.

The coil is preferably fixed in the axial direction via the recess. The receptacle of the coil preferably has a radially inwardly pointing projection which engages into the recess of the pole tube and, in particular, has a shape which corresponds to the cross section of the recess, with the result that the positively locking connection is configured between the receptacle and the pole tube.

In particular, the tube part is configured in one part or in one piece. The tube part is preferably configured from one piece, for example cast and, in particular, machined by means of machining methods such as turning, laser machining or milling. For example, the tube part is produced by cold working.

The tube part preferably extends in the axial direction beyond the coil and the valve block. Together with the housing upper part, the tube part preferably configures the outer wall of the damping valve device. The damping valve device preferably consists of a housing upper part and the tube part. The tube part is preferably connected directly to the housing upper part and the outer cylinder tube of the vibration damper.

For example, the tube part is connected to the pole tube in a positively locking, non-positive and/or integrally joined manner. In particular in the valve-side region, the pole tube preferably has a peripheral recess which interacts with a constriction of the tube part to form a positively locking connection.

For example, the pole tube is configured in one part and/or in one piece and surrounds the armature and the control slide. According to a further embodiment, the pole tube extends beyond the valve block in the axial direction. The valve block and the control slide are preferably completely enclosed peripherally and in the axial direction by the pole tube.

The damping valve device preferably has a flux plate made from a magnetic or magnetizable material, wherein the flux plate lies against the coil, the pole tube and/or the tube part. The flux plate is preferably attached to that end side of the coil which faces away from the valve region, and extends around the armature, in particular.

In particular, the magnetic circuit is configured from the coil, the pole tube, the tube part, the armature and the flux plate. The elements of the magnetic circuit are preferably configured completely or partially from a magnetic or magnetizable material. In particular, adjacent elements of the magnetic circuit lie directly against one another, in order to ensure a magnetic flux which is as resistance-free as possible.

For example, the flux plate is of circularly annular disk-shaped configuration and has, for example, at least one radial cutout. For example, the flux plate has a plurality of cutouts which point radially from the outside toward the inside and, in particular, are spaced apart uniformly from one another. The cutouts preferably extend over approximately from a third to half of the radius of the flux plate radially into the latter.

In accordance with a further embodiment, the damping valve housing has a housing upper part which is attached on the front side at one end of the tube part, wherein the pole tube extends from the housing upper part to the valve block. A plug-in contact for the electrical connection of the coil and, in particular, electrical lines which lead from the plug-in contact to the coil such as conductor tracks, sheet metal strips or copper strips are preferably arranged in the housing upper part. The housing upper part preferably configures a cover of the tube part.

The pole tube is connected, for example, to the valve block by means of a mechanical joint. A mechanical joint is preferably to be understood to mean a connection of two components by means of deforming, wherein at least one of the components is mechanically deformed. A connection of the pole tube to the valve block by deforming of the pole tube and/or the valve block makes simple pre-assembly of the pole tube on the valve block possible, with the result that it can be introduced together with the valve block into the tube part and connected to the latter. As a result, the assembly time and the assembly costs are considerably reduced.

The mechanical joint comprises, for example, a plastic deformation of the pole tube such as crimping and/or rolling of the pole tube. The end region of the pole tube is preferably deformed mechanically, in order to configure the mechanical joint between the pole tube and the valve block. In particular, a preloading element, for example a disk spring or a cup spring, is arranged between the pole tube and the valve block. The preloading element is configured, in particular, in such a way that it loads the pole tube with an axial spring force and preferably braces it against the valve block. For example, the pole tube has a deforming edge which is produced by means of plastic deformation of the pole tube, wherein the preloading element lies against it. The preloading element preferably lies against the valve block, in particular the comfort valve body.

The invention likewise comprises a vibration damper for a vehicle having a damping valve device as described above, wherein the vibration damper has an outer cylinder tube, and wherein the tube part of the damping valve device is connected to the cylinder tube, in particular directly. The cylinder tube is preferably connected to the tube part in a positively locking, non-positive and/or integrally joined manner. In particular, the cylinder tube is connected to the tube part via a fastening means. A comfort valve which, in particular, is connected hydraulically in series with the above-described damping valve device is preferably arranged in the tube part.

### DESCRIPTION OF THE DRAWINGS

The invention is explained in greater detail in the following text on the basis of a plurality of exemplary embodiments with reference to the appended figures.

FIG. 1 shows a diagrammatic illustration of a vibration damper with a damping valve device in a side view according to one exemplary embodiment.

FIG. 2 shows a diagrammatic illustration of a damping valve device in a sectional view according to one exemplary embodiment.

FIG. 3 shows three diagrammatic illustrations of in each case one valve block in a perspective view according to further exemplary embodiments.

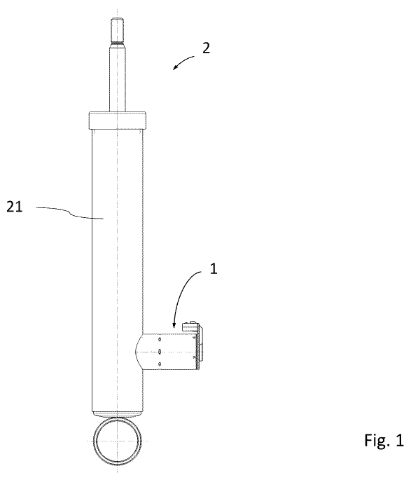

FIG. 1 shows a vibration damper 2 for a vehicle chassis, wherein the vibration damper 2 comprises a damping valve device 1. The vibration damper 2 of FIG. 1 is shown merely in an outside view. The vibration damper 2 preferably comprises a cylinder tube which has a hydraulic fluid received in it in a sealed manner, a piston which is axially movable along the cylinder tube axis within the cylinder tube and which divides the cylinder tube into two working spaces, and a piston rod which is oriented parallel to the cylinder tube axis and is connected to the piston. In particular, the piston has at least two fluid passages, by which the one working space is connected to the other working space. The vibration damper 2 is, for example, a multi-tube vibration damper. In particular, the vibration damper 2 has an inner cylinder tube, in which the piston is guided. For example, the outer cylinder tube 21 is attached coaxially around the inner cylinder tube, wherein an annular space is configured between the inner and the outer cylinder tube 21. A center tube which divides the annular space is preferably attached between the inner and the outer cylinder tube 21 and coaxially with respect to them. In order to damp the piston movement in at least one, preferably both, actuating direction/directions, a damping valve device 1 is connected to at least one of the working spaces. The damping valve device 1 is preferably attached to the center tube and the outer cylinder tube 21 of the vibration damper 2.

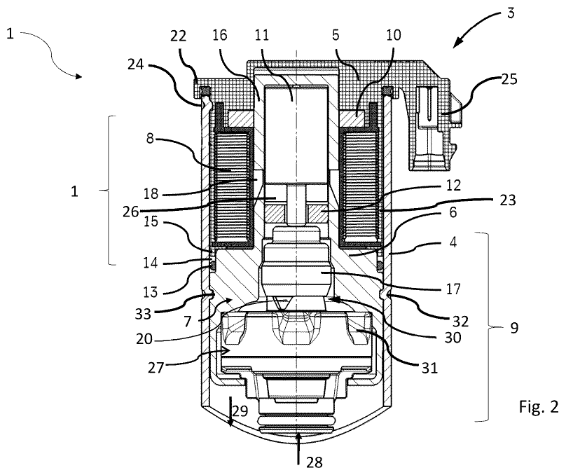

FIG. 2 shows a damping valve device 1 with a preferably cylindrical damping valve housing 3 which comprises a substantially tubular tube part 4 and a housing upper part 5 which is attached to the tube part 4. The tube part 4 is connected with its one end to the cylinder tube 21 (not shown in FIG. 2) of the vibration damper 2. The housing upper part 5 is attached to the other end of the tube part 4, lying opposite the cylinder tube 21, with the result that the housing upper part 5 preferably closes the tube part 4 on the end side. The housing upper part 5 has by way of example a circular-cylindrical cover portion 22 which has a greater diameter than the tube part 4 and projects radially beyond the tube part 4. The cover portion 22 is adjoined by a hollow cylinder portion 23 which has a smaller diameter than the tube part 4, in particular than the inner diameter of the tube part 4, and is arranged within the tube part 4 coaxially with respect to the latter. The housing upper part 5, in particular the hollow cylinder portion 23, preferably lies against the inner wall of the tube part 4. By way of example, the cover portion has an annular cutout on the side which points in the direction of the tube part 4, in which cutout the end of the tube part 4 is received. The tube part 4 is connected by way of example via a positively locking connection 24 to the housing upper part 5. The positively locking connection 24 is configured by way of example by a radial cutout in the housing upper part 5, into which cutout a radial constriction of the tube part 4 engages. The positively locking connection 24 is preferably configured at that end of the tube part 4 which faces the housing upper part 5. The housing upper part 5, in particular the cover portion 22, has a connector region 25 which has one or more terminal contacts for an electrical power supply of the damping valve device 1. The terminal contacts for an electrical power supply are preferably connected to a drive unit 19.

The damping valve device 1 has by way of example a drive region 19 and a valve region 9. The drive region 19 is arranged by way of example in the upper region of the damping valve device 1 which faces the housing upper part 5 and preferably substantially above the valve region 9. The drive region 19 preferably comprises a drive which is configured as an electromagnet. The electromagnet comprises a coil 8 with a plurality of windings made from a current-conducting wire. The coil 8 is preferably arranged within the tube part 4 and concentrically with respect to the latter. By way of example, the coil 8 is arranged within the hollow cylinder portion 23 of the housing upper part 5 and lies, in particular, against the inner wall of the housing upper part 5. In particular, the coil 8 is cast into the housing upper part 5, wherein the housing upper part 5 is configured, for example, from a plastic, in particular a material which is not magnetic or is only very slightly magnetic, preferably a magnetic insulator or a material with a high magnetic resistance. The coil comprises, for example, a coil former, onto which the windings of the coil are wound. The coil 8 encloses, at least partially or completely, an armature space 26 which extends centrally in the axial direction and concentrically with respect to the tube part 4. An armature 11 is mounted axially movably within the armature space 26. The armature 11 is preferably of cylindrical configuration and has a diameter which is slightly smaller than the diameter of the armature space 26, with the result that the armature 11 is preferably attached such that it can slide in the axial direction. By way of example, the armature 11 has an upper first cylindrical region which faces the housing upper part 5 and is adjoined on the valve region side by a second cylindrical region which is arranged coaxially with respect to the first region and has a smaller diameter. The armature space 11 is preferably delimited by a hollow cylinder 16 which is arranged coaxially with respect to and within the tube part 4. The hollow cylinder 16 preferably has a bottom and, in particular, is of open configuration in the direction of the cylinder tube 21. The bottom preferably points in the direction of the housing upper part 5 and, for example, lies at least partially against the latter. The hollow cylinder 16 is preferably configured from a magnetizable or magnetic material.

The coil 8 is preferably configured and arranged in such a way that, when loaded with current, it configures a magnetic field which has magnetic field lines which preferably run substantially in the axial direction in the armature space 26. The armature 11 is preferably configured from a magnetizable or magnetic material, and can be moved in the axial direction in accordance with the polarity of the magnetic field which is configured by means of the coil 8. In particular, a pole part 12 which is of hollow-cylindrical configuration and is arranged coaxially with respect to the tube part 4 is arranged within the armature space 26. The armature 11, in particular the second cylindrical region of the armature 11, extends in the axial direction centrally through the pole part 12. The pole part 12 is preferably configured from a magnetizable or magnetic material. The pole part 12 lies, in particular, against the inner wall of the hollow cylinder 16 and is, for example, connected fixedly to the latter. An annular space, through which, in particular, a hydraulic fluid can flow, is preferably configured between the pole part 12 and the armature 11.

A flux plate 10 is arranged peripherally around the hollow cylinder 16 and concentrically with respect to the latter. The flux plate 10 is preferably of hollow-cylindrical configuration and lies, in particular, against the outer wall of the hollow cylinder 16. Furthermore, the flux plate 10 lies at least partially against the tube part 4 and is preferably a magnetic flux connection between the hollow cylinder 16 and the tube part 4. The flux plate 10 preferably lies against the coil 8 and is, in particular, a magnetic flux connection between the hollow cylinder 16, the tube part 4 and/or the coil 8. The flux plate 10 has by way of example at least two cutouts which lie opposite one another, run in the radial direction from the outside toward the inside, and through which the section of the illustration of FIG. 2 runs.

The hollow cylinder 16 is adjoined in the axial direction and coaxially with respect thereto by a pole tube element 6. The pole tube element 6 and the hollow cylinder 16 together configure the pole tube 7, wherein the pole tube 7 is configured, in particular, in one piece or in one part. The pole tube element 6 is preferably configured in one part with the hollow cylinder 16 or is connected fixedly to the latter, for example in a positively locking, non-positive and/or integrally joined manner. The hollow cylinder 16 extends at least partially or completely in the axial direction along the coil 8. Together with the hollow cylinder 16, the pole tube element 6 preferably encloses at least the armature 11, the armature space 26 and the pole part 12.

The pole tube 7 has an upper tubular region with, in particular, a constant inner diameter, which region preferably comprises the hollow cylinder 16 and extends from the housing upper part in the axial direction as far as beyond the armature 11. The upper tubular region is adjoined in the axial direction by a lower region with a widened diameter, wherein the outer surface of the pole tube, in particular of the pole tube element 6, preferably extends as far as the tube part 4 and lies at least partially against the latter. The inner face of the lower region of the pole tube element 6 at least partially encloses a valve region 9 which is explained in more detail in one of the following paragraphs. The pole tube 7 preferably has a cutout 18 which is, for example, of annularly peripheral configuration in the pole tube wall. The cutout 18 is preferably arranged coaxially with respect to the coil 8 and, in particular, within the coil 8. The cutout 8 has by way of example a square cross section.

The pole tube element 6 of the pole tube 7 preferably has a plurality of different inner diameters which each configure cylindrical spaces of different diameter. Moreover, the pole tube 7 has, in particular, a plurality of different outer diameters. In the axial direction from the drive region 19 in the direction of the valve region 9, the pole tube 7 preferably has a first outer diameter which configures the hollow cylinder 16 and preferably extends along the coil 8. This is adjoined by a second outer diameter which is greater than the first outer diameter, with the result that a shoulder, in particular an axial end surface, is configured which points in the direction of the housing upper part 5 and against which the coil 8 lies at least partially by way of example. The second outer diameter is preferably smaller than the inner diameter of the tube part 4 and, in particular, is spaced apart from the latter in such a way that a chamber 14 is configured between the pole tube 7 and the tube part 4. The second outer diameter is adjoined by way of example by a third outer diameter of the pole tube 7 which is greater than the first and the second outer diameter and preferably corresponds substantially to the inner diameter of the tube part 4, with the result that the pole tube 7 lies with the third outer diameter against the tube part 4. A shoulder, in particular an axial end surface, which points in the direction of the housing upper part 5 is configured between the second and the third outer diameter. The pole tube element 6 is preferably configured from a magnetizable or magnetic material.

The chamber 14 is preferably configured to receive a sealing element 13, in particular a sealing ring. The chamber 14 is preferably of circularly annular configuration and has, in particular, a rectangular cross section. The chamber 14 is, in particular, completely closed and is delimited by the pole tube 7, the tube part 4 and by way of example the coil 8. The coil 8 preferably has a projection 15 which runs in the axial direction, in particular along the inner wall of the tube part 4, extends between the tube part 4 and the pole tube 7, and adjoins the chamber 14. The projection 15 is preferably configured from a plastic and is connected, in particular, in a positively locking manner to the pole part 7 and the tube part 4. That end face of the projection 15 which points in the valve direction preferably configures a boundary of the chamber 14.

A sealing element 13 is attached in the chamber 14, wherein the sealing element 13 is preferably a sealing ring. The sealing element 13 is by way of example of circularly annular configuration and preferably has a round, in particular circular, cross section. The sealing element 13 preferably lies at least against the pole tube 7 and the tube part 4 and serves to seal the valve region 9 with respect to the drive region 19, with the result that no hydraulic fluid passes from the valve region 9 into the coil 8. In particular, the sealing element 13 additionally lies against a shoulder, preferably the axial end face which is configured between the second and the third outer diameter of the pole tube 7.

As an alternative, it is possible that the projection 15 is configured as a supporting ring 15. The supporting ring 15 is by way of example configured separately from the coil 8 and lies at least partially with an outer surface against the latter. The supporting ring 15 is preferably of circularly annular configuration and has by way of example a rectangular cross section. In particular, the supporting ring lies with its outer surface against the inner side of the tube part 4 and with its inner surface against the outer surface of the pole tube 7. That end surface of the supporting ring 15 which points in the valve direction adjoins the chamber 14. The supporting ring 15 is preferably connected fixedly to the coil 8, the pole tube 7 and/or the tube part 4. The supporting ring 15 preferably forms a bearing surface for the sealing element 13.

The pole tube element 6 is preferably connected via a positively locking connection to the tube part 4. The positively locking connection preferably comprises a radial cutout, in particular depressions, in the pole tube element 6, into which a radial constriction of the tube part 4 engages and interacts with it in such a way that the pole tube element 6 is fixed in the axial and radial direction. The positively locking connection is, in particular, a bayonet connection. For example, the pole tube 7, in particular the pole tube element 6, has a plurality of cutouts 33 which are, in particular, of hook-shaped configuration. Each cutout 33 comprises, for example, a region which runs, in particular, in the axial direction and a region which adjoins the latter and runs in the peripheral direction. At least one or more radial constrictions 32 of the tube part 4 preferably engage into the cutout 33. The cutouts 33 are preferably radial depressions which are configured in the outer surface of the pole tube 7 which lies against the tube part 4. The cutouts 33 preferably extend into the chamber 14 and form, in particular, interruptions of the contact surface of the sealing element 13. FIG. 2 merely partially shows the regions of the cutouts 33 which run in the peripheral direction.

The valve region 9 is preferably integrated into a hydraulic circuit (not shown) and is connected fluidically to the vibration damper 2, in particular the working spaces of the vibration damper 2. The valve region 9 has an inflow 28 and an outflow 29, the functionality of which can be reversed depending on the flow direction of the damping fluid.

The valve region 9 of the damping valve device 1 preferably comprises a control slide 17 which is enclosed at least partially or completely peripherally by the pole tube element 6 and is arranged, in particular, coaxially with respect to the latter and the tube part 4. The control slide 17 preferably has an axial end surface which points in the direction of the armature 11 and on which the armature 11, in particular the lower second region of the armature 11, lies, with the result that a movement of the armature 11 is transmitted to the control slide 17.

Furthermore, the valve region 9 comprises a valve block 27. The control slide 17 preferably encloses the valve block 27 peripherally and is mounted movably in the axial direction relative to the valve block 27. The valve block 27 is, in particular, of funnel-shaped configuration and has by way of example an upper cylindrical region which faces the drive unit 19 and is arranged coaxially with respect to the control slide 17. On the lower region which faces away from the drive unit 19, the valve block 27 has by way of example a radial widened portion. The valve block 27 is attached, in particular, in a stationary manner relative to the axially movable control slide 17.

The valve block 27 is preferably enclosed peripherally and in the axial direction at least partially or completely by the pole tube element 6, wherein the control slide 17 is arranged between the upper region of the valve block 27 and the pole tube element 6. The lower region of the valve block 27 is arranged in the radial direction directly adjacently with respect to the pole tube element 6 and preferably lies at least partially against the latter. Passage openings and/or flow passages 20 (shown only partially), through which the damping fluid can flow from the inflow 28 in the direction of the outflow 29, are configured within the valve block 27. The control slide 17 is attached axially movably in such a way that it completely releases the flow passages 20 in an open position of the damping valve device 1 and completely closes the flow passages 20 in a closed position of the damping valve device 1. The control slide 17 can preferably assume a multiplicity of intermediate positions, in which the flow passages 20 are partially closed. The control slide 17 is preferably preloaded in the direction of an open valve position by means of a spring (not shown), with the result that, in the case of a de-energized coil 8, the damping valve is open. The spring is preferably arranged between the control slide 17 and the valve block 27, and preferably loads the control slide with a force which acts axially in the direction of the drive region 19. An annular gap 30 for conducting the damping fluid is preferably configured between the valve block 27 and the pole tube element 6. The annular gap 30 preferably extends completely around the upper region of the valve block 27 which can be enclosed by the control slide 17, and in particular at least partially or completely around the lower region of the valve block 27. The control slide 17 can preferably be moved axially within the annular gap 30.

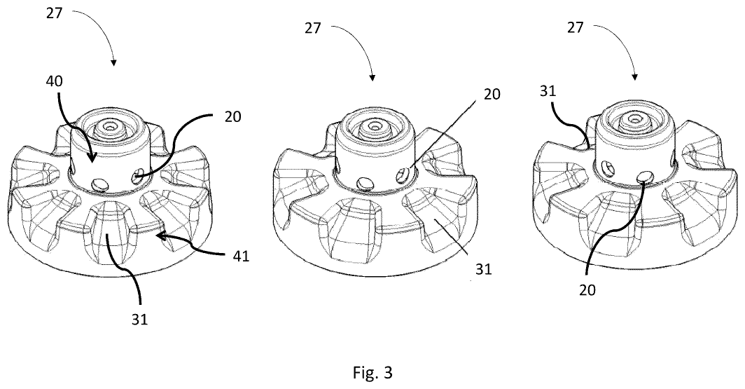

The valve region 9 preferably comprises a comfort valve and a solenoid valve which are connected hydraulically in series with one another. By way of example, the valve block 27 comprises two valve bodies. The valve body which points in the direction of the drive region is, for example, the solenoid valve body which is shown in FIG. 3, preferably has the above-described flow passages 20 and a plurality of flow channels 31, and interacts with the control slide 17 which can be moved by means of the coil 8. The solenoid valve body is preferably adjoined in the direction of the cylinder tube 21 of the vibration damper 2 by a comfort valve body (not shown in FIG. 3). By way of example, the valve block 27 which is optionally configured from a solenoid valve body and a comfort valve body is configured in one part or in one piece.

In particular, the fluid outflow 29 is configured between the valve block 27 and the pole tube 7. A plurality of flow channels 31 are preferably configured between the pole tube 7 and the valve block 27. The flow channels 31 are configured at least partially in the valve block 27. The flow channels 31 preferably extend along the pole tube 7, wherein the pole tube 7 preferably does not have any passage openings, in particular bores, for conducting the damping fluid through the pole tube wall.

The pole tube 7 extends by way of example at least partially in the axial direction along the comfort valve body. The end region of the pole tube 7 is preferably mechanically deformed, in order to configure a connection between the pole tube 7 and the valve block 27. The pole tube 7 and the valve block 27 are connected to one another, in particular, by means of a mechanical joint. The joint is by way of example a crimped connection or a rolled connection. That end region of the pole tube 7 which points in the direction of the comfort valve is preferably deformed radially inward, with the result that, in particular, a radially inwardly pointing deformed edge of the pole tube 7 is configured.

FIG. 3 shows a detailed view of the valve block 27 in three exemplary embodiments, wherein the valve block 27 corresponds to that of FIG. 2 apart from the differences described in the following text.

The valve block 27, in particular the solenoid valve body, has a first cylindrical region 40, in which the flow passages 20 are configured. The first region 40 is preferably adjoined in the direction of the fluid outlet 29 by a second substantially cylindrical region 41 with a greater diameter relative to the first region 40. The flow channels 31 are configured in the second region. The flow channels 31 are preferably of open configuration in the direction of the pole tube 7 (not shown in FIG. 3), with the result that the flow channels 31 are each configured between the inner surface of the pole tube 7 and the radially outwardly pointing surface of the valve block 27, in particular of the second region 41. The second region 41 has by way of example a radially outwardly pointing peripheral surface and a shoulder surface which points axially in the direction of the first region 40. The shoulder surface preferably lies against the pole tube 7. The flow channels 31 preferably extend from the shoulder surface to the peripheral surface and are, in particular, cutouts, preferably indentations, in the shoulder surface and the peripheral surface. By way of example, the direction of extent of the flow channels 31 has an axial and radial component. For example, the flow channels 31 extend continuously at an angle of from 10° to 80°, in particular from 20° to 60°, preferably from 30° to 50° with respect to the axial orientation. The flow channels 31 are by way of example of half shell-shaped configuration in the valve block 27 and extend, in particular, in a star-shaped manner away from the first region 40, in particular from the flow passages 20. By way of example, the flow channels 31 each extend from a radially inner completely circularly annular region of the shoulder surface outward as far as the peripheral surface. The flow channels 31 have, for example, a round, semicircular, circular, oval, rectangular or square cross section. All or a plurality of flow channels 31 are preferably of geometrically identical configuration and, in particular, are spaced apart from one another uniformly in the peripheral direction.

The first region 40 of the valve block 27 has the flow passages 20 and is preferably arranged coaxially with respect to the control slide 17 (not shown in FIG. 3). The first region 40 can preferably be enclosed completely or partially by the control slide 17. The flow passages 20 are preferably circular bores in the valve block 27, in particular the wall of the first region 40 of the valve block 27. By way of example, the flow passages 20 are arranged spaced apart uniformly from one another. The valve block 27 preferably has six flow passages 20 which are arranged peripherally around the first region 40 of the valve block 27 and, in particular, adjacent flow passages 20 are each arranged offset by 60° with respect to one another. The number of flow passages 20 is preferably an even number, in particular four, six, eight or 10.

The left-hand exemplary embodiment of FIG. 3 shows a valve block with six flow passages 20, wherein at least one flow passage 20 is arranged offset with respect to the radial extent of the adjacent flow channel 31. By way of example, three flow passages 20 are arranged offset with respect to the respective adjacent flow channel 31, wherein three flow passages 20 are each arranged in an aligned manner with a flow channel 31. The number of flow channels 31 is by way of example greater than the number of flow passages 20. Eight flow channels 31 are provided by way of example.

In the middle exemplary embodiment of FIG. 3, all the flow passages 20 are by way of example arranged in an aligned manner with a respective flow channel 31. The number of flow channels 31 corresponds by way of example to the number of flow passages 20.

In the right-hand exemplary embodiment of FIG. 3, all of the flow passages 20 are by way of example arranged offset with respect to the radial extent of the respective adjacent flow channel 31.

By way of example, the flow passages 20 have a circular cross section, wherein all flow passages 20 have the same diameter. It is likewise conceivable that at least two, a plurality of or all flow passages 20 have different diameters and/or geometries.

The flow passages 20 are optionally arranged at different height levels. For example, flow passages 20 which are directly adjacent with respect to one another are arranged at different height levels, wherein every second flow passage 20 is preferably arranged at the same height level. The height level is preferably to be understood to mean the spacing of the center point of the respective flow passage 20 from a cross-sectional plane. In particular, it is to be understood to mean the axial spacing of the center point of the respective flow passage 20 from the shoulder surface of the valve block 27.

All flow passages 20 are optionally arranged at different height levels. Flow passages 20 which lie opposite one another peripherally on the valve block 27 preferably have a height level difference which is smaller than the height level difference from the respective directly adjacent flow passages 20. As an alternative, flow passages 20 which lie opposite one another peripherally on the valve block 27 are arranged at the same height level.

The damping valve device 1 serves to adjust (in particular, in an infinitely variable manner) the damping of the vibration damper 2. During operation of the vibration damper 2, the coil 8 is loaded with electrical current in order to set the desired damping action. As a result, a magnetic field is generated, the magnetic field lines of which run substantially in the axial direction in the coil interior and, in particular, in the armature space 26. The magnetic flux of the magnetic field runs in a magnetic circuit which is configured within the damping valve device 1. The magnetic circuit comprises components made from materials with a low magnetic resistance, preferably from magnetic or magnetizable material. The magnetic circuit for conducting the magnetic field, in particular the magnetic flux, is preferably formed from the flux plate 10, the hollow cylinder 16, the pole tube element 6, the armature 11, the tube part 4 and/or the pole part 12. The armature 11 is moved in the axial direction in accordance with the polarity of the magnetic field. The movement of the armature 11 is transmitted to the control slide 17 which is coupled to the armature 11, with the result that this control slide closes or at least partially releases the flow passages 20 of the valve block 27. FIG. 2 shows by way of example an open position of the damping valve device 1.

### LIST OF DESIGNATIONS

1 Damping valve device
2 Vibration damper
3 Damping valve housing
4 Pipe part
5 Housing upper part
6 Pole tube element
7 Pole tube
8 Coil
9 Valve region
10 Flux plate
11 Armature
12 Pole part
13 Sealing element
14 Chamber
15 Projection/supporting ring
16 Hollow cylinder
17 Control slide
18 Recess
19 Drive unit
20 Flow passages
21 Cylinder tube
22 Cover portion
23 Hollow cylinder portion/receptacle
24 Positively locking connection
25 Connector region
26 Armature space
27 Valve block
28 Inflow/fluid inlet
29 Outflow/fluid outlet
30 Annular gap
31 Flow channels
32 Constriction
33 Cutout in the pole tube
40 First region
41 Second region

1-15. (canceled)

16. A damping valve device for a hydraulic vibration damper for a vehicle, comprising:
a drive region and a valve region; and
a damping valve housing with a tube part which encloses the drive region and the valve region;
wherein the drive region has a coil which is configured in such a way that it generates a magnetic circuit within the damping valve device and interacts with an armature, attached axially movably within the coil, in order to move the armature in the axial direction;
wherein the armature is arranged within a pole tube, and the pole tube forms a guide of the armature;
wherein the valve region has a fluid inlet and a fluid outlet for admitting and discharging a hydraulic fluid into/out of the valve region, and a valve block with a plurality of flow passages for conducting the hydraulic fluid;
wherein the valve region has a control slide which is attached such that it can be moved relative to the valve block in such a way that it can be moved between a closed position, in which the flow passages are closed by the control slide, and an open position, in which the flow passages are free;
wherein a plurality of flow channels which extend at least partially in the radial and in the axial direction are configured between the pole tube and the valve block.

17. The damping valve device as claimed in claim 16, wherein the valve block has a first cylindrical region and an adjoining second cylindrical region, wherein the second region has a greater diameter than the first region, and wherein the flow channels are configured in the second region.

18. The damping valve device as claimed in claim 17, wherein the pole tube lies against the second region of the valve block.

19. The damping valve device as claimed in claim 16, wherein the flow channels extend at an angle of from 10° to 80° with respect to the axial orientation.

20. The damping valve device as claimed in claim 16, wherein the flow channels extend at an angle of from 20° to 60° with respect to the axial orientation.

21. The damping valve device as claimed in claim 16, wherein the flow channels extend at an angle of from 30° to 50° with respect to the axial orientation.

22. The damping valve device as claimed in claim 16, wherein the flow passages are configured in the first region.

23. The damping valve device as claimed in claim 16, wherein the number of flow channels corresponds to the number of flow passages.

24. The damping valve device as claimed in claim 16, wherein at least one flow channel is arranged in an aligned manner with one of the flow passages.

25. The damping valve device as claimed in claim 16, wherein at least one flow channel is arranged offset with respect to the flow passages.

26. The damping valve device as claimed in claim 16, wherein at least two flow passages are arranged at different height levels.

27. The damping valve device as claimed in claim 26, wherein at least two flow passages are arranged at the same height level.

28. The damping valve device as claimed in claim 16, wherein flow passages which lie opposite one another peripherally on the valve block are arranged at the same height level.

29. The damping valve device as claimed in claim 16, wherein flow passages which lie opposite one another peripherally on the valve block have a height level difference which is smaller than the height level difference from the respective directly adjacent flow passages.

30. The damping valve device as claimed in claim 16, wherein the pole tube extends beyond the valve block in the axial direction.

31. The damping valve device as claimed in claim 16, wherein the damping valve housing has a housing upper part which is attached on the front side at one end of the tube part, and wherein the pole tube extends from the housing upper part to the valve block.

32. A vibration damper for a vehicle having a damping valve device as claimed in claim 16, wherein the vibration damper has an outer cylinder tube, and wherein the tube part of the damping valve device is connected to the cylinder tube.
